(19) United States
(12) Patent Application Publication
(10) Pub. No.: US 2009/0055933 A1
(43) Pub. Date: Feb. 26, 2009

(54) System, Method and Machine-Readable Medium for Periodic Software Licensing

(76) Inventor: Ehab M. Samuel, Newport Beach, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/843,604

(22) Filed: Aug. 22, 2007

(51) Int. Cl. H04L 9/32

(52) U.S. Cl. 726/26; 705/1

(57) ABSTRACT

A system and method for periodically licensing a software having a server configured to receive a first request code for a term extension of a software license, the request code being initiated by a user of an application unit, the term extension allows the software to operate within a predetermined period of time, provide advertising information to the application unit, and provide the term extension for the software license.

### BACKGROUND

This disclosure relates generally to software, and more particularly, to a system, method and machine-readable medium for periodic software licensing.

### SUMMARY

A system and method for periodically licensing software having a server configured to receive a first request code for a term extension of a software license, the request code being initiated by a user of an application unit, the term extension allows the software to operate within a predetermined period of time, to provide advertising information and/or educational information to the application unit, and to provide the term extension for the software license. The server may further be configured to provide the application unit with at least one question or query on the advertising information and/or educational information, and wherein the server provides the term extension if the at least one question or query on the advertising information and/or educational information is answered correctly by the user. The server may further be configured to provide special offers on the advertising information, the special offers is selected from a group consisting of discounts, rebates and credits. The may determine an expiration date of the software license and send a notification of the expiration date to the application unit. The server may further be configured to receive a third request code for a sample of a product advertised and a fourth request code to order a product advertised.

According to a feature of the present disclosure, the system for periodic software licensing is disclosed. The system includes a processor coupled to a server, the processor receives license term information from a license term module and user identity information from an identity module, the processor being in a blocked mode if a software license has expired based on the license term information, the processor sends a first request code to the server for access to advertising information, the processor receives from the server advertising information for display and a term extension for the software license.

According to a feature of the present disclosure, a machine-readable medium is disclosed. The machine-readable medium provides instructions, which when read by a processor, cause the machine to perform operations including receiving license term information from a license term module and user identity information from an identity module, sending a first request code to access content information, the first request code being initiated by a user of the machine-readable medium, the machine-readable medium being in a blocked mode if a software license has expired based on the license term information, the content information is selected from a group consisting of advertising information and educational information, and receiving content information for display and a term extension for the software license.

According to a feature of the present disclosure, the method for renewing a license to a software in a blocked mode is disclosed. The method includes sending a first request code to access advertising information using the software in blocked mode, receiving advertising information for display, and receiving an unblock code for the software, the unblock code renews the license for a predetermined period of time.

According to a feature of the present disclosure, a machine-readable medium is disclosed. The machine-readable medium provides instructions, which when read by a processor, cause the machine to perform operations including sending a first request code to access content information, the first request code being initiated by a user of the machine-readable medium, the machine-readable medium being in a blocked mode, the content information is selected from a group consisting of advertising information and educational information, receiving content information for display, and receiving an unblock code for the machine-readable medium, the unblock code allows the machine-readable medium to operate within a predetermined period of time.

According to a feature of the present disclosure, an interfacing control system and a method for conditionally interfacing content information approved for continuing education credits to a user of a software program and for periodic software licensing is disclosed. The interface control system includes a server configured to receive a first professional license information of the user from an application unit, retrieve a second professional license information of the user from a memory, verify the authenticity of the first professional license information by comparing the first professional license information with the second professional license information, qualify the user to access content information by verifying the user's profession and directing the user to access at least one content information related to the user's profession, provide content information to the application unit, and extend the software license for a predetermined period of time. The server may further be configured to electronically submit the first professional license information and accessed content information to a governing body in the profession.

According to a feature of the present disclosure, a system and method for periodic software licensing and providing targeted content information to a software program is disclosed. The system includes a server configured to receive a first request code from the software program to access content information, determine classification of the software program, receive highest record achieved in the software program, selectively provide content information to the software program based on the classification of the software program and the highest score, level or record achieved in the software program, and extend the software license for a predetermined period of time. The server may selectively provide content information to the software program using a comparator that compares the highest record achieved in the software program with a predetermined record attributed to the content information.

According to a feature of the present disclosure, a method for periodically receiving targeted content information in a software program and a machine-readable medium is disclosed. The machine-readable medium provides instructions, which when read by a processor, cause the machine to perform operations including sending a first request code for a term extension of a software license to a server, the term extension allows a software program to operate within a predetermined period of time, providing the server with a classification code of the software program, receiving content information based on the classification code of the software program, and receiving the term extension for the software license. The machine-readable medium may also cause the machine to perform operations including forwarding a highest record achieved in the software program to the server, and receiving content information based on the highest record achieved in the software program.

### DRAWINGS

The above-mentioned features and objects of the present disclosure will become more apparent with reference to the following description taken in conjunction with the accompanying drawings wherein like reference numerals denote like elements and in which:

FIG. 1 is an exemplary block diagram of a system for periodic software licensing, according to one embodiment of the present invention.

FIG. 2 is an exemplary block diagram of an application unit, according to one embodiment of the present invention.

FIG. 3 is an exemplary block diagram of an identity module, according to one embodiment of the present invention.

FIG. 4 is an exemplary block diagram of a license term module, according to one embodiment of the present invention.

FIG. 5 is an exemplary flowchart outlining the operation of an application unit for periodic software licensing, according to one embodiment of the present invention.

FIG. 6 is an exemplary flowchart outlining the operation of a server for periodic software licensing, according to one embodiment of the present invention.

FIG. 7 is an exemplary flowchart outlining the operation of the server for periodic software licensing, according to another embodiment of the present invention.

FIG. 8 is an exemplary flowchart outlining the operation of the server for periodic software licensing, according to another embodiment of the present invention.

FIG. 9 is an exemplary flowchart outlining the operation of the server for periodic software licensing, according to another embodiment of the present invention.

FIG. 10 is an exemplary flowchart outlining the operation of the server for periodic software licensing, according to another embodiment of the present invention.

FIG. 11 is an exemplary flowchart outlining the operation of the server for periodic software licensing, according to another embodiment of the present invention.

FIG. 12 is an exemplary flowchart outlining the operation of the server for periodic software licensing, according to another embodiment of the present invention.

FIG. 13 is an exemplary flowchart outlining the operation of the application unit, according to an embodiment of the present invention.

FIG. 14 is an exemplary flowchart outlining the operation of the server for conditionally interfacing content information to the application unit, according to an embodiment of the present invention.

FIG. 15 is an exemplary flowchart outlining the operation of the server for providing targeted content information based on a user's past game performance, according to an embodiment of the invention.

FIG. 16 is an exemplary flowchart outlining the operation of a machine-readable medium for receiving targeted content information based on a user's past performance, according to an embodiment of the invention.

### DETAILED DESCRIPTION

Reference will now be made to a preferred embodiment, examples of which are illustrated in the accompanying drawings. While the invention will be described in conjunction with the preferred embodiments, it will be understood that these embodiments are not intended to limit the scope of the invention. On the contrary, the invention is intended to cover alternatives, modifications, and equivalents, which may be included within the spirit and scope of the invention as defined by the appended claims. As such, the description of the embodiments that follow are for purposes of illustration and not limitation.

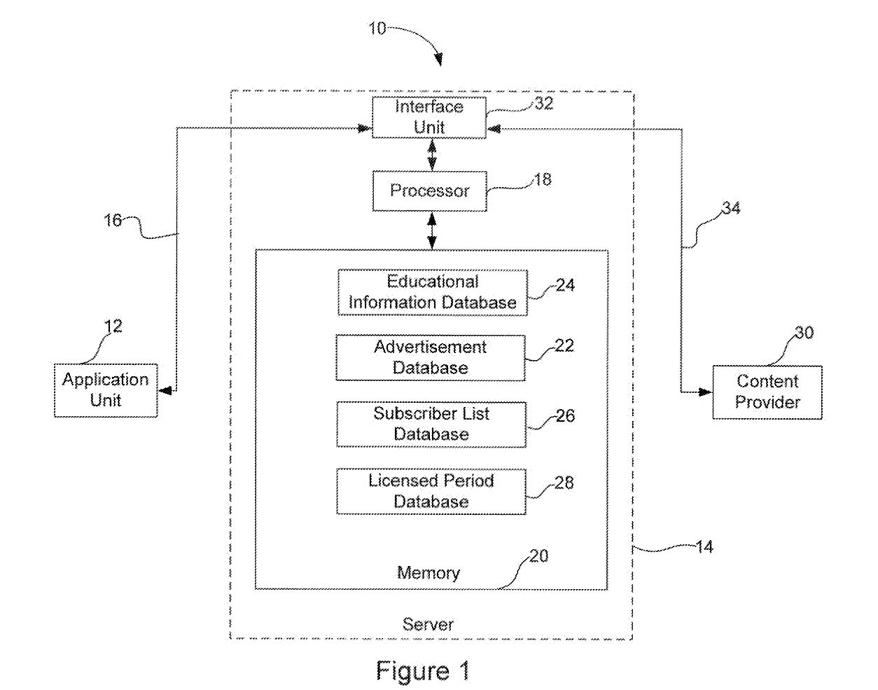

FIG. 1 is an exemplary block diagram of a system 10 for periodic software licensing, according to one embodiment of the present invention. The system 10 may include an application unit 12 and a server 14. The application unit 12 may be used to operate a software program that requires periodic licensing. For example, software program that requires a user to obtain a license on a monthly basis. The application unit 12 is coupled to the server 14 via a network 16, such as, the Internet, WAN, LAN, wireless network, satellite network, or any combinations thereof.

The server 14 may include a processor 18, a memory 20 and an interface unit 32. The processor 18 may be configured to receive a request, in the form of data signals, such as a request code, for a term extension of a software license, the request code being initiated by a user of an application unit, the term extension allows the software to operate within a predetermined period of time. The processor 18 may be further configured to provide advertising information and/or educational information to the application unit, and provide the term extension for the software license. The processor 18 may also be configured to process answers to questions or queries on the advertising information and/or educational information, verify that a predetermined number of questions from the at least one question on the advertising information and/or educational information is answered correctly, update user license status and provide the term extension for the software license. The term extension may be an access code that allows the software program to operate within a predetermined period of time. The memory 20 may include an advertisement database 22, an educational information database 24, a subscriber list database 26 and a licensed period database 28.

The advertisement database 22 may include advertising information and special offers on the advertising information, such as, but not limited to, discounts, rebates and credits relating to the advertising information. The advertising information may include text, audio, images and/or video. For example, the advertising information may be a 2-minute video commercial on a product offered in the marketplace. Hence, if the application unit 12 is used, for example, to play a video game, the advertising information may include a 2-minute commercial on another video game or game console. In one embodiment, the advertisement database 22 includes at least one question or query on the advertising information and its corresponding correct answer. This is to ensure that the user is watching the video commercial. If the user wants or needs to renew, extend or maintain the term of the software license, the user needs to watch the video commercial and answer correctly a predetermined number of questions or query from the at least one question or query on the advertising information. For example, the server 14 may be configured to provide the user with three questions on the advertising information and provide the term extension if two or all three questions on the advertising information are answered correctly. In the event that a question is answered incorrectly, the server 14 may be configured to provide a replay of a segment from the advertising information that pertains to the question. The advertising information may be bookmarked into segments that correspond to particular questions. The user may be provided with an opportunity to re-answer the question once the corresponding segment from the advertising information has been replayed.

The advertising information may be sponsored by one or more companies seeking to target the user operating the application unit 12. It can be envisioned that the advertising material may be a video commercial on a plurality of products for one or more sponsoring companies. For example, if the application unit 12 is used for operating a dental management software, a commercial on a toothpaste, a mouth wash, a composite material or a dental impression material may be provided with at least one question or query on the commercial. If the user wants to renew or extend the term of the software license, the user needs to watch the video commercial and answer correctly a predetermined number of questions from the at least one question on the commercial. This ensures that the user is watching the advertising information offered by the advertising companies. By delivering advertising information directly to the user's application unit 12 and requiring the user to watch the advertising information and correctly answer questions pertaining thereto, the sponsoring companies no longer need to hire a large number of sales representatives traveling to various dental and medical offices to advertise their company's products. Moreover, users, such as dentists and doctors, willingly seek access to the advertising information, at their convenience, to maintain their software license, as opposed to being interrupted and inconvenienced during the day by sales representatives. In one embodiment, the user can request the server 14 for samples of the products offered by the sponsor, for example, toothpaste samples for dentists. In another embodiment, the user can order/purchase the product advertised on by the sponsor.

The educational information database 24 may include educational information, such as continuing education content or informational content. The educational information may include text, audio, images and/or video. Informational content may be news, reports, articles, or other informational material. Continuing education content allows the user to receive continuing education credits for maintaining his or her professional license to practice. For example, the continuing education content may be a 60-minute video on ethics in the profession. Another example includes a 60-minute video on a dental or medical procedure using certain products in the marketplace. It can be envisioned that the user submits his or her professional license to the server 14, wherein the server 14 verifies the user's license information, qualifies the user to access continuing education information and submits the user's license information and accessed continuing education information to the appropriate governing body in the profession for certification and/or continuing education credits. The continuing education content may be divided into multiple blocks of time, for example, a 60-minute session may be divided into six 10-minute sessions to allow for flexibility in viewing the continuing education content. In one embodiment, the educational information database 24 includes at least one question or query on the educational information and its corresponding correct answer. This is to ensure that the user is watching the displayed educational information.

It can be envisioned that the application unit 12 may be used to operate a dental or a medical management software. If the user of the software wants or needs to renew, extend or maintain the term of the software license, the user needs to watch the educational information and answer correctly a predetermined number of questions from the at least one question on the educational information. The server 14 may be configured to receive a request code to access the educational information. The server 14 may be further configured to provide the user with at least one question or query on the educational information and provide the term extension if a predetermined number of questions from the at least one question on the educational information is answered correctly. In the event that a question or query is answered incorrectly, the server 14 may be configured to provide a replay of a segment from the educational information that pertains to the question. The educational information may be bookmarked into segments that correspond to particular questions. The user may be provided with an opportunity to re-answer the question once the corresponding segment from the educational information has been replayed.

The educational information may be sponsored by one or more companies seeking to target the user operating the application unit 12. For example, informational content may be sponsored by news companies, educational institutions or organizations, or any other company providing informational material to the user. It can be envisioned that the informational material may be admissions requirement to a specific department of a sponsoring university or college. For example, if the application unit 12 is used to play a video game, the informational material may include admissions information to the Computer Science Department of the sponsoring university or college. In one embodiment, the application unit 12 sends the user's highest game score along with the request code to receive informational content. This allows universities, colleges, and companies to send targeted advertisement based on the users game score.

Continuing education content may be sponsored by pharmaceutical companies, medical device companies, or any other company seeking to target the user operating the application unit 12. In one embodiment, the user can request the server 14 for samples of the products offered by the sponsor, for example, toothpaste samples for dentists. In another embodiment, the user can order the product advertised on by the sponsor. For example, the server 14 may be configured to receive a request code to order a product advertised.

The subscriber list database 26 may include a list of users operating the software with periodic licensing requirements on the application unit 12. The licensed period database 28 may include the license term for each user on the subscriber list database 26. The server 14 may be configured to determine an expiration date of the software license for a user on the subscriber list database 26. In one embodiment, the server 14 notifies the user of the expiration date by prompting the software to issue a notification or reminder of the expiration date of the software license. This provides the user with sufficient time to extend the term of the software license prior to its expiration date. Hence, the user maintains the software license for a predetermined period of time, for example, one month, by watching content information, such as advertising information or educational information, and answering correctly a predetermined number of questions from at least one question on the content information.

In one embodiment, content information, such as advertising information or educational information, is provided by a content provider 30. The server 14 receives a request code from the user for a term extension of the software license and forwards content information from the content provider 30 to the application unit 12. The server 14 interfaces with the application unit 12 to provide content information from the content provider 30.

In one embodiment, the interface unit 32 couples the content provider 30 and the processor 18 to the application unit 12. The interface unit 32 couples the server 14 to the content provider 30 via a network 34, such as, the Internet, WAN, LAN, or any combinations thereof. The interface unit 32 may incorporate switching mechanisms that controls the transfer of content information to the application unit 12 after processor 18 processes the request code to receive the content information. According to one embodiment, the interface unit 32 may be adapted to conditionally interface with the application unit 12. As such, the interface unit 32 determines whether or not the request code to receive content information meets one or more predetermined conditions, and thereby controls switching mechanism for providing conditional interface. For example, predetermined conditions for interfacing the content information to the application unit 12 may include, but not limited to, professional license information and volume of request codes to receive content information.

The interface unit 32 may be adapted to conditionally interface with the application unit 12 if a professional license information provided by the user for accessing continuing education information is verified. It can be envisioned that the user submits his or her professional license to the server 14, whereby the server 14 verifies the user's license information, qualifies the user to access continuing education information and allows the application unit 12 to interface with the content provider 30 and/or processor 18.

Another condition for interfacing may be dependant on the volume of request codes to receive content information. When server 14 is actuated by the interface unit 32 to provide content information to a plurality of users, the network 16 may not have sufficient bandwidth to provide content information to multiple users simultaneously. As such, server 14 may be configured to cue request codes to receive content information from a plurality of users by providing a predetermined message or question, in the form of text, audio, image or video. The server 14 stores the user's software license information in the order of request code received, cues the request code received if necessary and processes the request code in the order of request received.

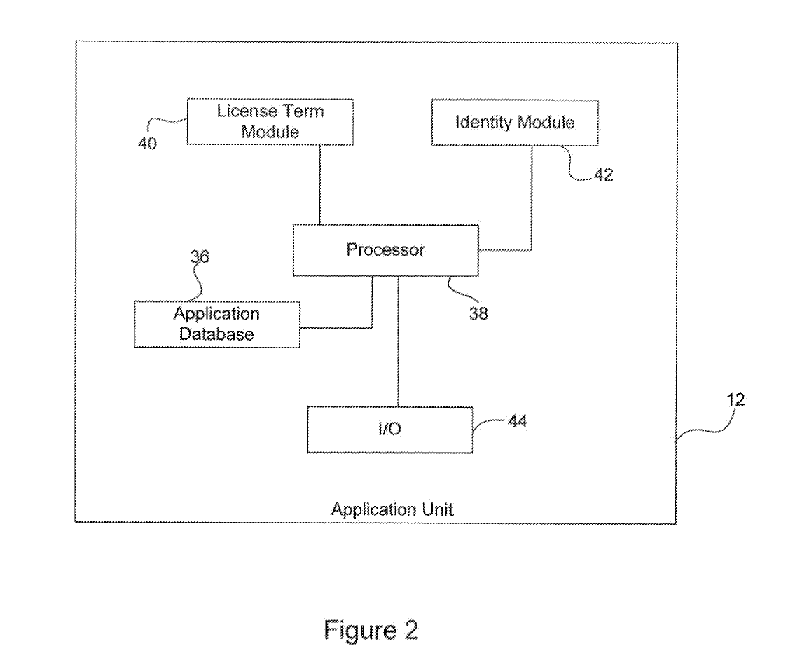

FIG. 2 is an exemplary block diagram of the application unit 12, according to one embodiment of the present invention. The application unit 12 may include an application database 36, a processor 38, a license term module 40, an identity module 42 and input and output components 44. The application unit 12 may be used to operate a software program that requires periodic licensing. The software program may be stored in the application database 36 and executed by the processor 38. The software program can be implemented using hardware, software or a combination of hardware and software. The application database 36 can be implemented in a machine-readable medium, which may be any mechanism that provides (i.e. stores and/or transmits) information in a form readable by the processor 38. For example, the machine-readable medium may be a read only memory (ROM), a random access memory (RAM), a cache, a hard disk drive, a floppy disk drive, a magnetic disk storage media, an optical storage media, a flash memory device or any other device capable of storing information. The application database 36 may be used to store, arrange and retrieve data.

The machine-readable medium may provide instructions, which when read by processor 38, cause: the machine to perform operations, such as requesting a term extension for a software license, the term extension allows the software to operate within a predetermined period of time, receiving content information selected from a group consisting of advertising information and educational information, and receiving the term extension for the software license.

The machine-readable medium may also provide instructions, which when read by processor 38, cause the machine to perform operations, such as determining an expiration date of a license for the machine-readable medium, providing notification of the expiration date, sending a first request code to access content information, the first request code being initiated by a user of the machine-readable medium, the content information is selected from a group consisting of advertising information and educational information, receiving content information for display, and receiving a term extension for the license, the term extension allows the machine-readable medium to operate within a predetermined period of time.

The input and output components 44 may include a display, a keyboard, a controller, a microphone, a speaker or any components that can be used to input and output information in the application unit 12. The processor 38 may be configured to control the operations of the input and output components 44.

In one embodiment, the processor 38 receives license term information from the license term module 40 and user identity information from the identity module 42. Based on the license term information, the processor 38 may enter a blocked mode if the software license has expired. When the application unit 12 is in blocked mode, the processor 38 blocks the software program from operating until the software license is renewed. Being in a blocked mode, the processor 18 may be actuated by the user to send a first request code to the server 14 to access content information and receive from the server 14 content information for display and a term extension for the software license. The term extension provides an unblock code that allows the application unit 12 to operate the software program. The unblock code renews the software license for a predetermined period of time. In one embodiment, the unblock code is received if a predetermined number of questions from the at least one question on the content information is answered correctly.

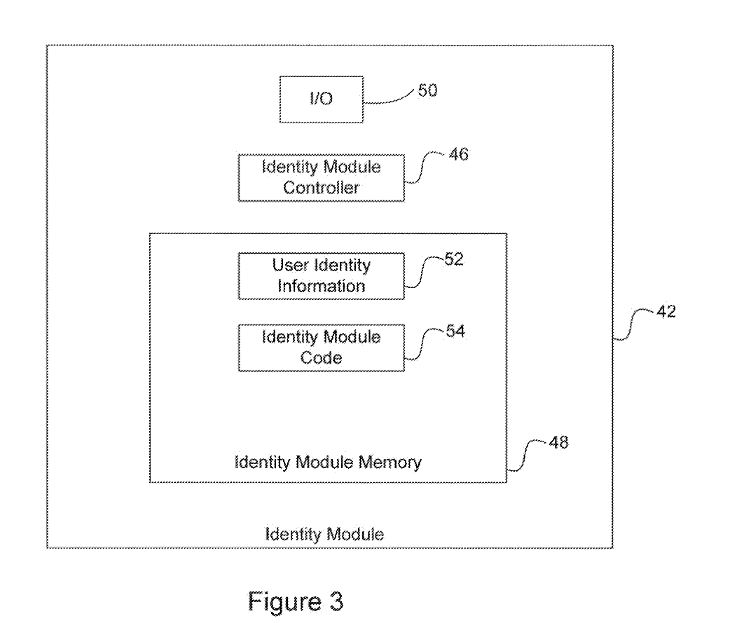

FIG. 3 is an exemplary block diagram of the identity module 42, according to one embodiment of the present invention. The identity module 42 may include an identity module controller 46, an identity module memory 48 and input and output circuitry 50. The identity module memory 48 may include a user identity information 52 and an identity module code 54.

In operation, the identity module controller 46 executes the identity module code 54 for operation of the identity module 42. The identity module controller 46 controls access to data located in the identity module memory 48. The identity module controller 46 sends user identity information 52 to the processor 38 when the application unit 12 is actuated by the user to access content information. The input and output circuitry 50 can communicate with the circuitry of the application unit 12 to send user identity information 52 to the processor 38. Alternatively, the user can manually enter user identity information 52 via the input and output components 44. In one embodiment, the user identity information 52 may include the user's professional license for accessing continuing education information. The identity module controller 46 may require a password to verify the user's identity and permit the transfer of user identity information 52 to the processor 38. The identity module controller 46 can block access to the user identity information 52 if the password entered by the user does not correspond to the password saved in the identity module memory 48.

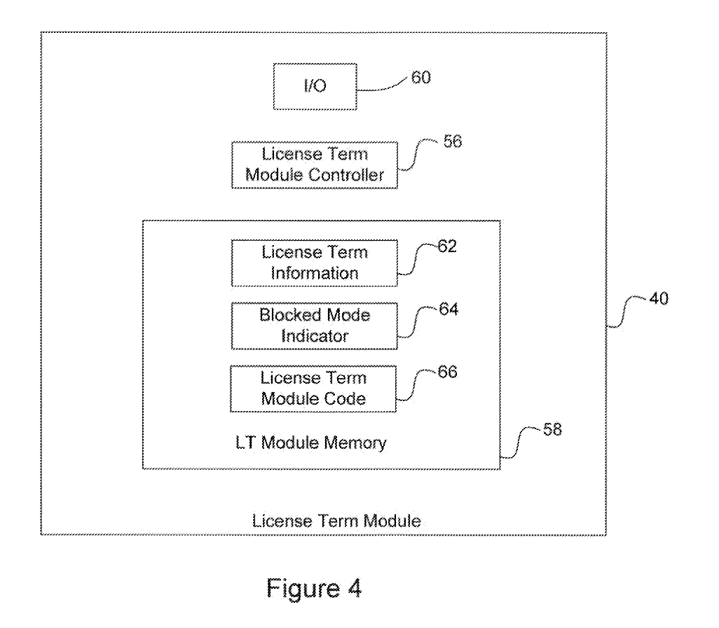

FIG. 4 is an exemplary block diagram of a license term module 40, according to one embodiment of the present invention. The license term module 40 may include a license term module controller 56, a license term module memory 58 and input and output circuitry 60. The license term module memory 58 may include a license term information 62, a blocked mode indicator 64 and a license term module code 66. The blocked mode indicator 64 may be a register that indicates a blocked mode of the license term module 40 or the application unit 12.

In operation, the license term module controller 56 executes the license term module code 66 for operation of the license term module 40. The license term module controller 56 controls access to data located in the license term module memory 58. The license term module controller 56 sends license term information 62 to the processor 38. The input and output circuitry 60 can communicate with the circuitry of the application unit 12 to send license term information 62 to the processor 38.

In one embodiment, the blocked mode indicator 64 may have a blocked mode status and an unblocked mode status. The blocked mode indicator 64 may be used to indicate whether the license term module 40 is blocked or unblocked. The license term module controller 56 may be configured to send instructions to the processor 38 to grant access to the software program when the blocked mode indicator 64 is in an unblocked mode status. Conversely, the license term module controller 56 may be configured to send instructions to the processor 38 to deny access to the software program when the blocked mode indicator 64 is in a blocked mode status.

Based on the license term information 62, the processor 38 may enter blocked mode status if the software license has expired. When the application unit 12 is in blocked mode, the processor 38 blocks the software program from operating until the software license is renewed. While in blocked mode, the license term module controller 56 may be configured to send instructions to the processor 38 to grant access to specific features of the software program that enables the user to renew the software license. This allows the user to actuate the processor 38 to send a request code to access content information and receive an unblock code for the software license. The license term module controller 56 may switch the license term module 40 to an unblocked mode upon receipt of an unblock code from the server 14. The unblock code renews the software license for a predetermined period of time. Once the predetermined period expires, the blocked mode indicator 64 switches from the unblocked mode back to the blocked mode.

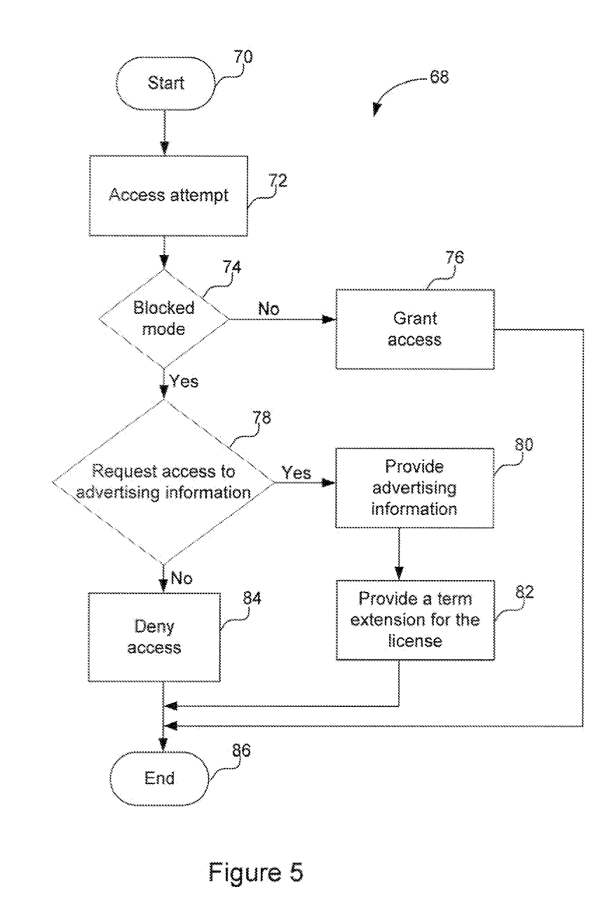

FIG. 5 is an exemplary flowchart 68 outlining the operation of the application unit 12 for periodic software licensing. The system and method for periodic software licensing begins (70) when a user attempts to access the software program (72). The license term module 40 determines if the software program is in blocked mode (74). For example, the blocked mode indicator 64 may be checked to determine whether the license term module 40 is blocked or unblocked. If the blocked mode indicator 64 is in an unblocked mode status, access is granted to the software program (76). However, if the blocked mode indicator 64 is in a blocked mode status, a determination is made if a request code to access content information, such as advertising information, is made (78). If the request code to access content information is made, the content information is provided to the user (80) as well as a term extension for the software license (82). In one embodiment, the method for renewing a license to the software program in blocked mode includes, sending a first request code to access advertising information using the software program in blocked mode, receiving advertising information for display, and receiving an unblock code for the software program, the unblock code renews the license for a predetermined period of time. In one embodiment, the unblock code is received if a predetermined number of questions from the at least one question on the advertising information is answered correctly. If the request code to access content information is not made, access is denied (84). As such, the system and method for periodic software licensing ends by granting or denying access to the software program (86).

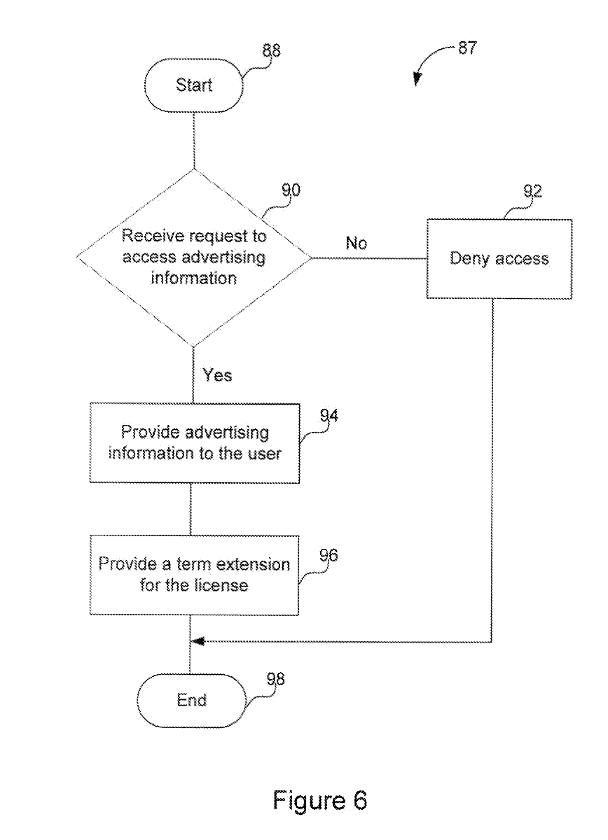

FIG. 6 is an exemplary flowchart 87 outlining the operation of the server 14 for periodic software licensing. The system and method for periodic software licensing begins (88) with a determination by the server 14 of whether a request code to access content information, such as advertising information, was made prior to expiration of the software license (90). In one embodiment, the server 14 determines the expiration date of the software license and notifies the user of the expiration date. If the user does not request code to access content information prior to the expiration date, the server 14 denies access to the software program after the expiration date (92). If the request code to access content information was made prior to the expiration date, the interface unit 32 is actuated to provide the content information to the application unit 12 from the memory 20 or the content provider 30 (94). The server 14 also provides the application unit 12 with a term extension for the software license, such as an unblock code for a predetermined period of time (96). The server 14 updates its subscriber list database 26 and associated licensed period database 28. The server 14 ends by granting or denying access to the software program on the application unit 12 (98).

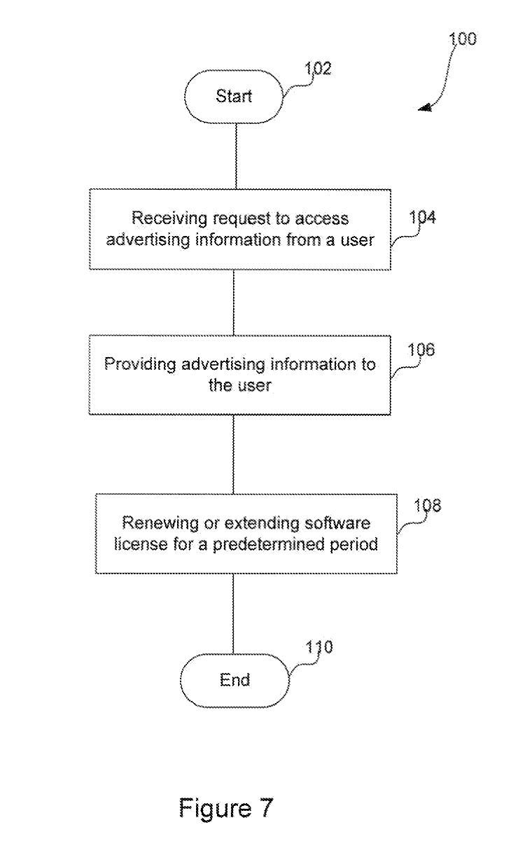

FIG. 7 is another exemplary flowchart 100 outlining the operation of the server 14 for periodic software licensing. The system and method for periodic software licensing begins (102) by receiving a request code to access advertising information from a user (104). The interface unit 32 provides the advertising information to the application unit 12 from the memory 20 or the content provider 30 (106). The server 14 renews or extends the software license by providing the application unit 12 with a term extension, such as an unblock code for a predetermined period of time (108). The method ends by updating the subscriber list database 26 and associated licensed period database 28 (110).

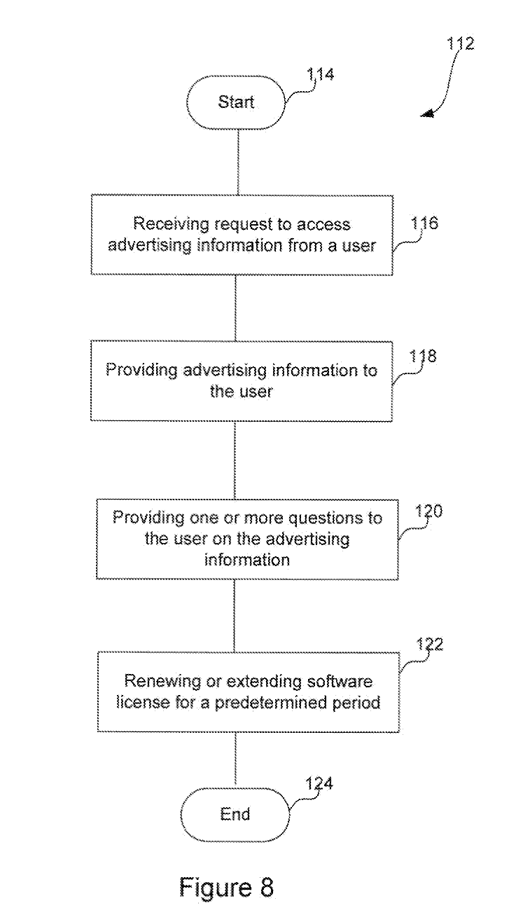

FIG. 8 is yet another exemplary flowchart 112 outlining the operation of the server 14 for periodic software licensing. The system and method for periodic software licensing begins (114) by receiving a request code to access advertising information from a user (116). The interface unit 32 provides the advertising information to the application unit 12 from the memory 20 or the content provider 30 (118). The interface unit 32 also provides one or more questions to the user on the advertising information (120). If the user answers the one or more questions incorrectly, the server 14 may be configured to replay a segment from the advertising information that pertains to the question. Once the user answers the one or more questions correctly, the server 14 renews or extends the software license by providing the application unit 12 with a term extension, such as an unblock code for a predetermined period of time (122). The method ends by updating the subscriber list database 26 and associated licensed period database 28 (124).

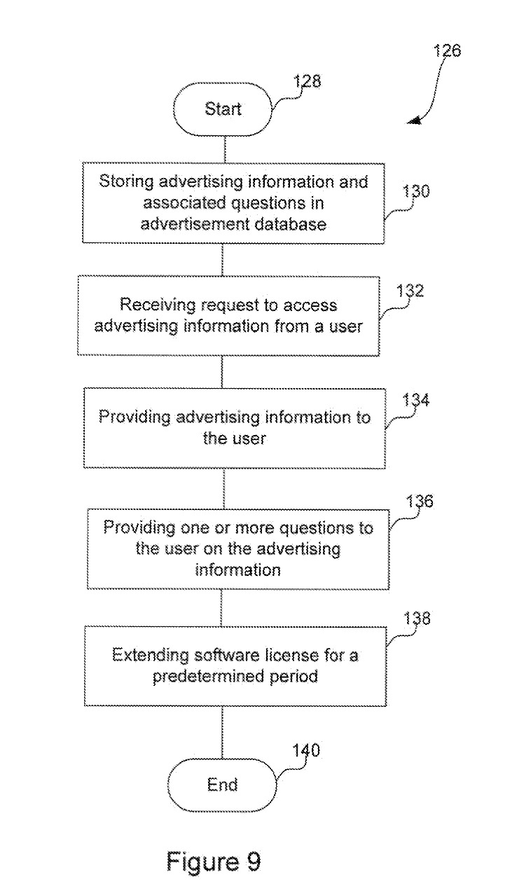

FIG. 9 is another exemplary flowchart 126 outlining the operation of the server 14 for periodic software licensing. The system and method for periodic software licensing begins (128) by storing advertising information and associated questions in advertisement database 22 (130). Upon receiving a request code to access advertising information from a user (132), the interface unit 32 provides the advertising information to the application unit 12 from the advertisement database 22 (134). The interface unit 32 also provides one or more questions to the user on the advertising information (136). If the user answers the one or more questions incorrectly, the server 14 may be configured to replay a segment from the advertising information that pertains to the question. Once the user answers the one or more questions correctly, the server 14 renews or extends the software license by providing the application unit 12 with a term extension, such as an unblock code for a predetermined period of time (138). The method ends by updating the subscriber list database 26 and associated licensed period database 28 (140).

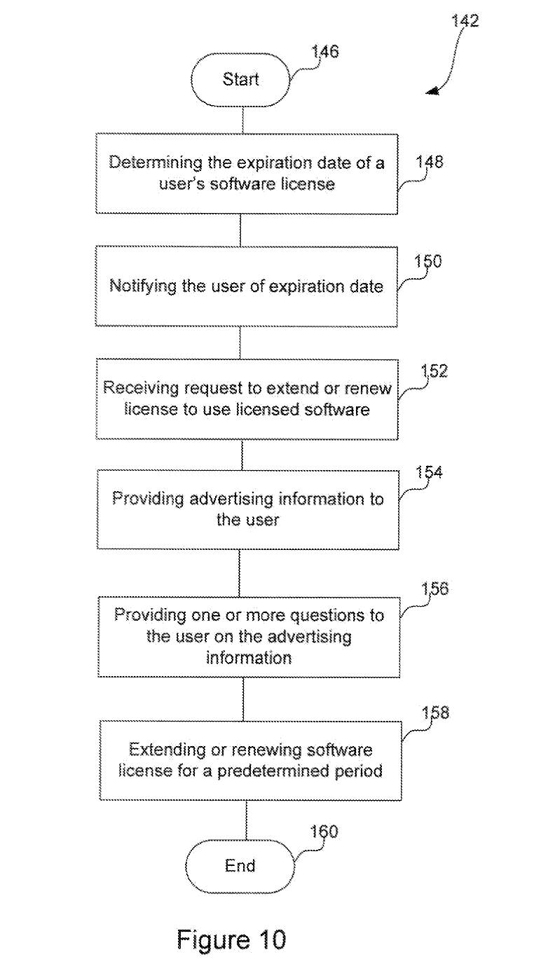

FIG. 10 is yet another exemplary flowchart 142 outlining the operation of the server for periodic software licensing. The system and method for periodic software licensing begins (146) by determining the expiration date of a user's software license (148) and notifying the user of the expiration date (150). In one embodiment, the server 14 determines the expiration date of the software license and notifies the user of the expiration date. In another embodiment, the software program may be configured to determine the expiration date of the software license and notify the user of the expiration date. Upon receiving a request code to extend or renew the software license (152), the interface unit 32 provides advertising information to the application unit 12 from the memory 20 or the content provider 30 (154). The interface unit 32 also provides one or more questions to the user on the advertising information (156). If the user answers the one or more questions incorrectly, the server 14 may be configured to replay a segment from the advertising information that pertains to the question. Once the user answers the one or more questions correctly, the server 14 renews or extends the software license by providing the application unit 12 with a term extension, such as an unblock code for a predetermined period of time (158). The method ends by updating the subscriber list database 26 and associated licensed period database 28 (160).

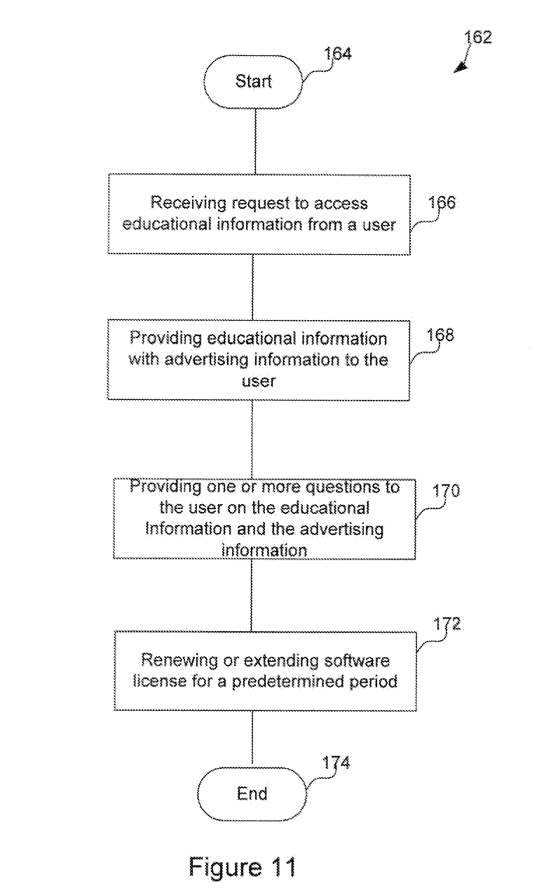

FIG. 11 is an exemplary flowchart 162 outlining the operation of the server 14 for periodic software licensing. The system and method for periodic software licensing begins (164) by receiving a request code to access educational information from a user (166). The interface unit 32 provides the educational information with advertising information to the application unit 12 from the memory 20 or the content provider 30 (168). The interface unit 32 also provides one or more questions to the user on the educational information and the advertising information (170). If the user answers the one or more questions incorrectly, the server 14 may be configured to replay the segment pertaining to the question. Once the user answers the one or more questions correctly, the server 14 provides the application unit 12 with a term extension for the software license, such as an unblock code for a predetermined period of time (172). The method ends by updating the subscriber list database 26 and associated licensed period database 28 (174).

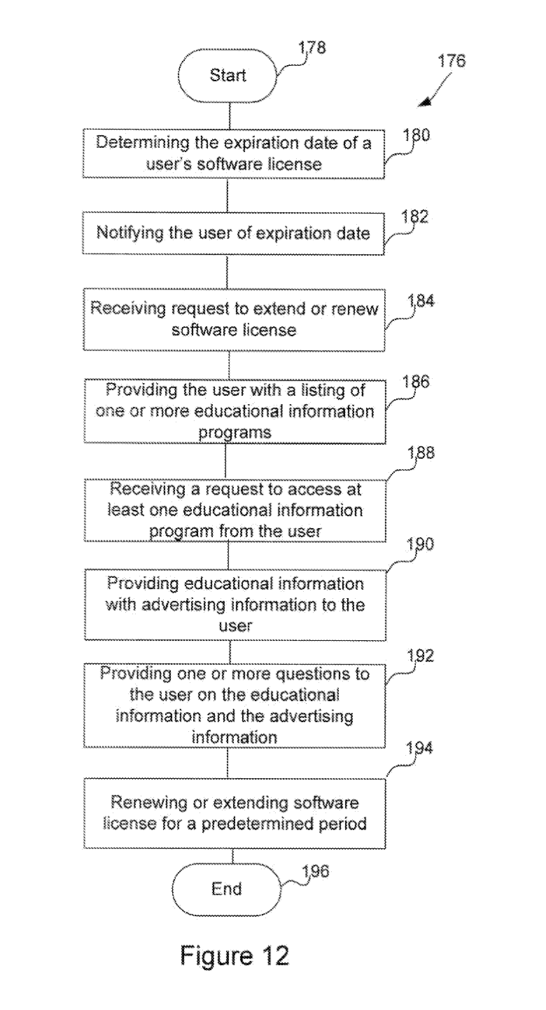

FIG. 12 is another exemplary flowchart 176 outlining the operation of the server 14 for periodic software licensing. The system and method for periodic software licensing begins (178) by determining the expiration date of a user's software license (180) and notifying the user of the expiration date (182). In one embodiment, the server 14 determines the expiration date of the software license and notifies the user of the expiration date. In another embodiment, the software program may be configured to determine the expiration date of the software license and notify the user of the expiration date. Upon receiving a request code to extend or renew the software license (184), the interface unit 32 provides the user with a listing of one or more educational information programs (186). The interface unit 32 receives a request code to access at least one educational information program from the user (188) and provides the requested educational information along with advertising information to the application unit 12 from the memory 20 or the content provider 30 (190). The interface unit 32 also provides one or more questions to the user on the educational information and advertising information (192). If the user answers the one or more questions incorrectly, the server 14 may be configured to replay a segment pertaining to the question. Once the user answers the one or more questions correctly, the server 14 renews or extends the software license by providing the application unit 12 with a term extension, such as an unblock code for a predetermined period of time (194). The method ends by updating the subscriber list database 26 and associated licensed period database 28 (196).

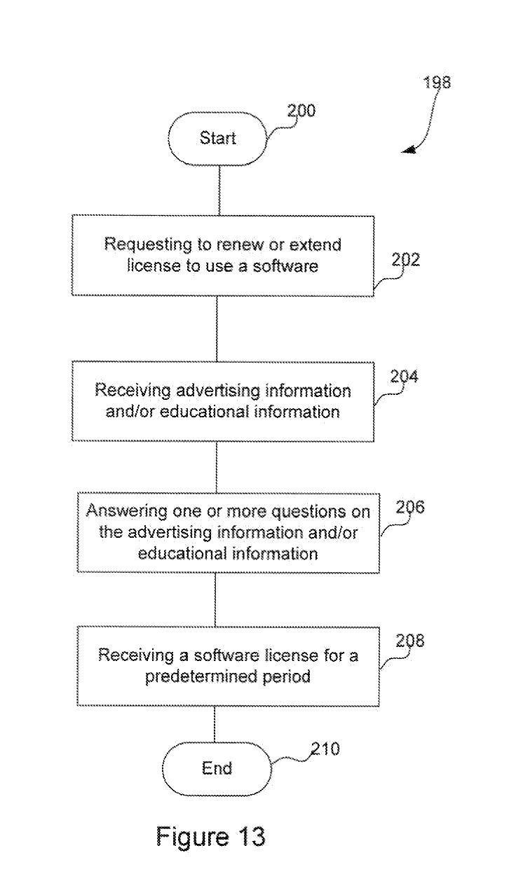

FIG. 13 is an exemplary flowchart 198 outlining the operation of the application unit 12. The system and method for periodic software licensing begins (200) by sending a request code from application unit 12 to renew or extend a software license (202). The application unit 12 then receives advertising information or educational information with advertising information (204). The application unit 12 also receives one or more questions on the advertising information and educational information, if provided. If the application unit 12 sends an incorrect answer to one or more questions, the application unit 12 may receive a replay segment pertaining to the question. If the application unit 12 sends correct answers to the server 14 (206), the application unit 12 receives a term extension to the software license, such as an unblock code for a predetermined period of time (208). The application unit 12 may continue operation until the predetermined period of time expires or the license is further extended or renewed (210).

According to one embodiment, the system for periodically licensing a software includes processor 38 of application unit 12 coupled to server 14, the processor 38 receives license term information from a license term module 40 and user identity information from an identity module 42, the processor 38 being in a blocked mode if a software license has expired based on the license term information, the processor 38 sends a request code to the server 14 for access to advertising information, the processor 38 receives from the server 14 advertising information for display and a term extension for the software license.

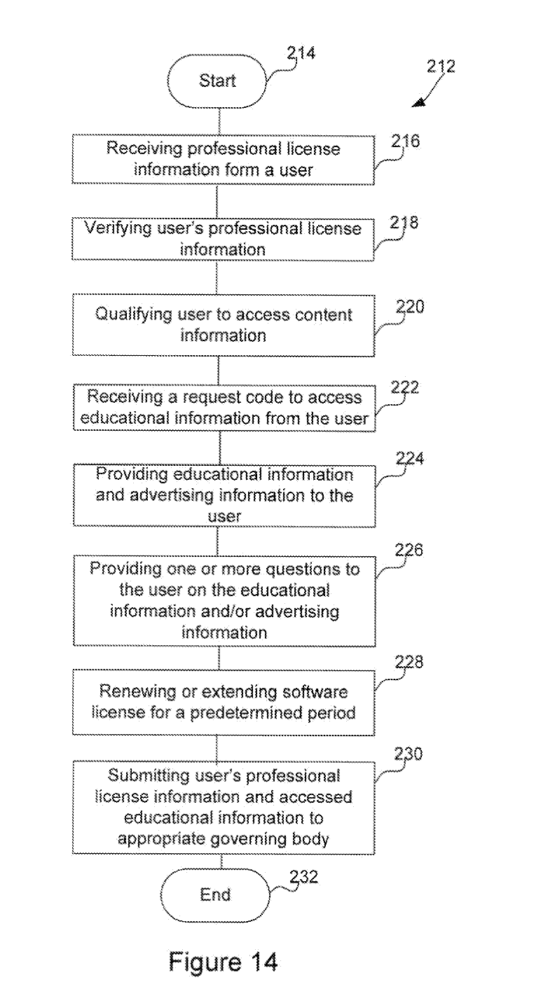

FIG. 14 is an exemplary flowchart 212 outlining the operation of server 14 for conditionally interfacing content information to the application unit 12. The interface control system and method for conditional interfacing begins (214) when server 14 receives a user's professional license information from application unit 12 (216). In one embodiment, the user may be prompted to manually enter the professional license information in the software program on application unit 12 with every request code to access content information. In another embodiment, the user's professional license information may be stored in identity module memory 48 and transmitted with every request code to access content information.

Upon receiving the user's professional license information, the server 14 may be configured to verify the user's professional license information (218). For example, the server 14 may store the user's professional license information in memory 20, retrieve user's professional license information from the memory 20 with every request code to access educational information, and compare user's professional license information stored in memory 20 with that received from application unit 12. The server 14 may utilize a comparator (not shown) to determine if the professional license information received is correct. If the professional license information received is incorrect, the interface unit 32 of server 14 denies access to educational information. However, if the professional license information is correct, the interface unit 32 of server 14 allows access to educational information. In one embodiment, the server 14 may employ a qualification unit (not shown) to qualify the user to access educational information (220). For example, the qualification unit may verify the user's profession and direct the user to a listing of one or more educational information programs related to the user's profession. The qualification unit may verify the user's profession by obtaining such information from memory 20 or prompting user to identify his/her profession.

The server 14 then receives a request code to access at least one educational information program from the user (222) and provides the requested educational information along with advertising information to the application unit 12 from memory 20 or content provider 30 (224). The server 14 also provides one or more questions to the user on the educational information and/or advertising information (226). If the user answers the one or more questions incorrectly, the server 14 may be configured to replay a segment pertaining to the question. Once the user answers the one or more questions correctly, the server 14 renews or extends the software license by providing the application unit 12 with a term extension, such as an unblock code for a predetermined period of time (228). The server 14 may also be configured to submit the user's professional license information and accessed educational information to the appropriate governing body in the profession for certification and/or continuing education credits (230). The method ends by updating the subscriber list database 26 and associated licensed period database 28 of the license term extension (232).

According to one embodiment, an interface control system for providing content information approved for continuing education credits to a user of a software program and for periodically licensing the software program is provided. The interface control system includes a server configured to receive a first professional license information of the user from an application unit, retrieve a second professional license information of the user from a memory, verify the authenticity of the first professional license information by comparing the first professional license information with the second professional license information, qualify the user to access content information by verifying the user's profession and directing the user to access at least one content information related to the user's profession, provide content information to the application unit, and extend the software license for a predetermined period of time. The server may also be configured to provide the user with at least one question on the content information, and wherein the server provides the software license is extended if a predetermined number of questions from the at least one question on the content information is answered correctly. Furthermore, the server may be configured to electronically submit the first professional license information and accessed content information to a governing body in the profession. The server may also be configured to determine an expiration date of the software license, and notify the user of the expiration date. Additionally, the server may be configured to receive a request code for a sample of a product advertised and/or a request code to order a product advertised with content information.

According to another embodiment, a method for conditionally interfacing content information approved for continuing education credits to a user of a software program and for periodically licensing the software program is provided. The method includes receiving a first professional license information of the user from an application unit, retrieving a second professional license information of the user from a memory, verifying the authenticity of the first professional license information by comparing the first professional license information with the second professional license information, qualifying the user to access content information by verifying the user's profession and directing the user to access at least one content information related to the user's profession, providing content information to the application unit, and extending the software license for a predetermined period of time. The method may also include providing the user with at least one question on the content information, wherein the software license is extended if a predetermined number of questions from the at least one question on the content information is answered correctly. Additionally, the method may include electronically submitting the first professional license information and accessed content information to a governing body in the profession.

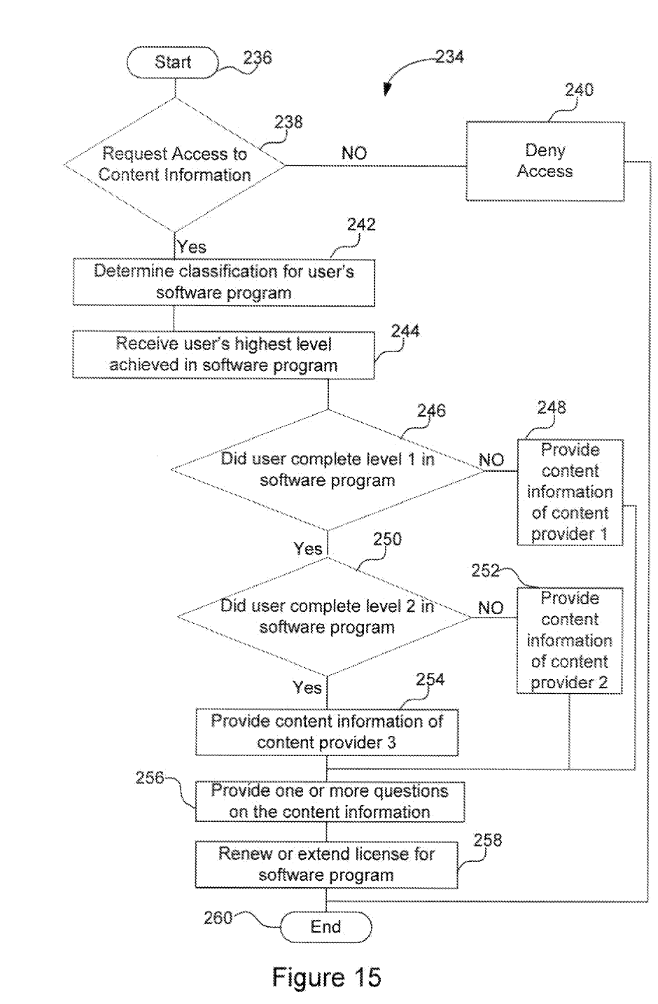

FIG. 15 is an exemplary flowchart 234 outlining the operation of the server 14 for providing targeted content information based on the user's past software performance. The targeted content information may be provided, for example, to a user with a predetermined score in a video game. The system and method for providing targeted content information begins (236) with a determination by the server 14 of whether a request code to access content information, such as advertising information, was made prior to expiration of the software license (238). In one embodiment, the server 14 determines the expiration date of the software license and notifies the user of the expiration date. If the user does not request to access content information prior to the expiration date, the server 14 denies access to the software program after the expiration date (240). If the request code to access content information was made prior to the expiration date, the server 14 may employ a classification unit (not shown) to determine the classification of the user's software (242). For example, the user's software may be a video game classified or categorized for combat activities, sports activities, educational activities, etc. In one embodiment, the classification unit receives a classification code from the application unit 12. For instance, the application unit 12 may be configured to read instructions from a machine readable medium containing classification code to a software program. The machine readable may be programmed to provide the server 14 with the classification code for the software program and the user's highest level or score achieved in the software program (244).

The server 14 may employ a comparator (not shown) to selectively provide content information to a user depending on the level or skill of the user. For example, a first comparator may be used to determine if the user completed level 1 in the software program (246). If the user did not complete level 1 in the software program, the interface unit 32 may be actuated to provide the user with content information of content provider 1 (248). If the user completed level 1 in the software program, the server 14 may employ a second comparator (not shown) to determine if the user completed level 2 in the software program (250). If the user did not complete level 2 in the software program, the interface unit 32 may be actuated to provide the user with content information of content provider 2 (252). However, if the user completed level 2 in the software program, the interface unit 32 may be actuated to provide the user with content information of content provider 3 (254) and so on.

In one embodiment, the server 14 may be configured to provide one or more questions to the user on the content information (256). The server 14 may also provide the application unit 12 with a term extension for the software license, such as a n unblock code for a predetermined period of time (258). The server 14 updates its subscriber list database 26 and associated licensed period database 28 and ends the method for providing targeted content information by granting or denying access to the software program on the application unit 12 (260).

As can be envisioned by a person skilled in the art, the targeted content information may generally be an advertisement on another product or service. The advertisement may be targeted based on classification of the software program. For example, games with combat activities may receive targeted advertisements sponsored by the navy, army, or marines. Games with sports activities may receive targeted advertisements sponsored by major leagues, universities, colleges, etc. Games with educational activities may receive targeted advertisements sponsored by educational institutions. In one embodiment, the application unit 12 sends the user's highest game score along with the request code to receive content information. This allows universities, colleges, and companies to send targeted advertisement based on the user's game score.

According to one embodiment, a system for periodically providing targeted content information to a software program is provided. The system includes a server configured to receive a request code from the software program to access content information, determine classification of the software program, receive highest score, level or record achieved in the software program, selectively provide content information to the software program based on the classification of the software program and the highest score, level or record achieved in the software program, and extend a license to use the software program for a predetermined period of time. The server may selectively provide content information to the software program using a comparator that compares the highest score, level or record achieved in the software program with a predetermined score, level or record attributed to the content information. The server may further be configured to provide the user with at least one question on the content information, and wherein the server extends the license to use the software program if the at least one question on the content information is answered correctly. Additionally, the server may further be configured to provide special offers on the content information, the special offers is selected from a group consisting of discounts, rebates and credits. The server may also be configured to receive a request code for a sample of a product advertised and/or a request code to order a product advertised with content information.

According to another embodiment, a method for periodically providing targeted content information to a software program is provided. The method includes receiving a request code from the software program to access content information, determining classification of the software program, receiving highest score, level or record achieved in the software program, selectively providing content information to the software program based on the classification of the software program and the highest score, level or record achieved in the software program, and extending a license to use the software program for a predetermined period of time. The method may also include comparing the highest score, level or record achieved in the software program with a predetermined score, level or record attributed to the content information. Additionally, the method may include providing the user with at least one question on the content information, wherein the license to use the software program is extended if a predetermined number of questions from the at least one question on the content information is answered correctly.

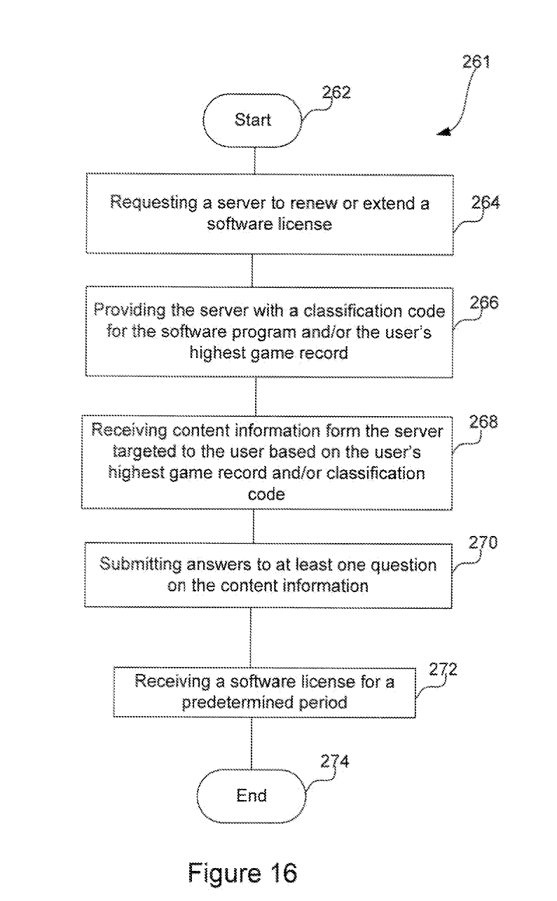

FIG. 16 is an exemplary flowchart 261 outlining the operation of a machine-readable medium for receiving targeted content information based on a user's past performance. The targeted content information may be provided, for example, to a user with a predetermined score in a video game. The machine-readable medium may provide instructions (262), which when read by processor 38 of application unit 12, cause the application unit to perform operations, such as sending to the server 14 a request code to renew or extend license to use a software program (264). The request code to renew or extend license to use the software may be associated with a request code to access content information, such as advertising information. The machine-readable medium may also instruct processor 38 to provide the server 14 with a classification code for the software program and/or the user's highest level or score achieved in the software program, such as the user's highest game record (266). Subsequently, the processor 38 of application unit 12 receives content information from the server 14 targeted to the user based on the user's highest game record and/or classification code (268).

In one embodiment, the extension or renewal of the license to use the software program may be conditioned on answering correctly a predetermined number of questions from at least one question provided by the server 14 to application unit 12. The machine-readable medium may instruct processor 38 to submit the answers to at least one question on the content information to server 14 (270). The processor 38 then receives from server 14 a term extension for the software license, such as an unblock code for a predetermined period of time (272). The application unit 12 may continue operation until the predetermined period of time expires or the license is further extended or renewed (274).

According to one embodiment, a machine-readable medium is provided. The machine-readable medium provides instructions, which when read by a processor, cause the machine to perform operations comprising sending a first request code for a term extension of a software license to a server, the term extension allows a software program to operate within a predetermined period of time, providing the server with a classification code of the software program, forwarding a highest score, level or record achieved in the software program to the server, receiving content information based on the classification code of the software program and/or the highest score, level or record achieved in the software program, and receiving the term extension for the software license.

According to another embodiment, a method for periodically receiving targeted content information in a software program is provided. The method includes sending a first request code for a term extension of a software license to a server, the first request code being initiated by a user of the software program, the term extension allows a software program to operate within a predetermined period of time, providing the server with a classification code of the software program, forwarding a highest score, level or record achieved in the software program to the server, receiving content information based on the classification code of the software program and/or the highest score, level or record achieved in the software program, and receiving the term extension for the software license.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. For example, any combination which performs a functionally analogous task as server 14 is understood within the scope of the specification to be included within the definition of the server. Likewise, artisans understand that for the purpose of the instant disclosure, the server 14 may include any number of serially linked units performing these functions within the scope of this invention.

As can be envisioned by a person skilled in the art, the systems, methods and machine-readable mediums may be used to provide cheaper software, and/or electronics embodying the software, by offsetting the price reduction with revenue generated from sponsored advertisements. Electronics, such as cell phones, cameras, media players, computers, and machinery employing electronics or software, such as vehicles, motorbikes, and the like, may be sold at a reduced price, or even distributed at no cost to the consumer while maintaining profitability by obtaining revenue through sponsored advertisements and other content information.

Those skilled in the art will appreciate that various adaptations and modifications of the just described preferred embodiments may be configured without departing from the scope and spirit of the invention. Therefore, it is to be understood that, within the scope of the appended claims, the invention the invention may be practiced other than as specifically described herein.

1. A system for periodic software licensing, comprising:
a processor coupled to a server, the processor receives license term information from a license term module and user identity information from an identity module, the processor being in a blocked mode if a software license has expired based on the license term information, the processor sends a first request code to the server for access to advertising information, the processor receives from the server advertising information for display and a term extension for the software license.

2. The system of claim 1, wherein the processor further receives at least one query on the advertising information, and wherein the processor receives the term extension if the at least one query on the advertising information is answered correctly.

3. The system of claim 1, wherein the processor further receives special offers on the advertising information, the special offers is selected from a group consisting of discounts, rebates and credits.

4. The system of claim 1, wherein the server determines an expiration date of the software license and sends a notification of the expiration date to the processor.

5. The system of claim 1, wherein the processor sends a second request code for a sample of a product advertised.

6. The system of claim 1, wherein the processor sends a third request code to purchase a product advertised.

7. The system of claim 1, wherein the processor sends a fourth request code to the server for access to educational information.

8. The system of claim 7, wherein the processor further receives at least one query on the educational information, and wherein the processor receives the term extension if the at least one query on the educational information is answered correctly.

9. A method for renewing a license to a software in a blocked mode, comprising:
sending a first request code to access advertising information using the software in blocked mode;
receiving advertising information for display; and
receiving an unblock code for the software, the unblock code renews the license for a predetermined period of time.

10. The method of claim 9, further comprising receiving at least one question on the advertising information, wherein the unblock code is received if a predetermined number of questions from the at least one question on the advertising information is answered correctly.

11. The method of claim 9, further comprising providing special offers on the advertising information, the special offers is selected from a group consisting of discounts, rebates and credits.

12. The method of claim 9, further comprising:
determining an expiration date of the license when the software is in an unblocked mode; and
providing a notification of the expiration date.

13. The method of claim 9, further comprising sending a second request code to access educational information.

14. The method of claim 9, further comprising sending a third request code for a sample of a product advertised.

15. The method of claim 9, further comprising sending a fourth request code to purchase a product advertised.

16. A machine-readable medium that provides instructions, which when read by a processor, cause the machine to perform operations comprising:
requesting a term extension for a software license, the term extension allows the software to operate within a predetermined period of time;
receiving content information selected from a group consisting of advertising information and educational information; and
receiving the term extension for the software license.

17. The machine-readable medium of claim 16, further comprising receiving at least one query on the content information, wherein the term extension is received if a predetermined number of queries from the at least one question on the content information is answered correctly.

18. The machine-readable medium of claim 16, further comprising receiving special offers on the content information, the special offers is selected from a group consisting of discounts, rebates and credits.

19. The machine-readable medium of claim 16, further comprising sending a first request code for a sample of a product advertised.

20. The machine-readable medium of claim 16, further comprising sending a second request code to purchase a product advertised.
